(19) United States
(12) Patent Application Publication
(10) Pub. No.: US 2026/0243505 A1
(43) Pub. Date: Aug. 20, 2026

(54) CRYOGENIC TYPE BOIL-OFF GAS RELIQUEFACTION SYSTEM

(71) Applicant: SHANGHAI MARINE DIESEL ENGINE RESEARCH INSTITUTE, Shanghai (CN)

(72) Inventors: Jingya FENG, Shanghai (CN); Xiaobo LI, Shanghai (CN); Qiye JIN, Shanghai (CN); Yan ZHANG, Shanghai (CN); Yu BAO, Shanghai (CN); Teng SHEN, Shanghai (CN); Jianan DAI, Shanghai (CN); Xiangli ZHU, Shanghai (CN); Qingpeng JI, Shanghai (CN); Shien TU, Shanghai (CN)

(21) Appl. No.: 19/130,172

(22) PCT Filed: Nov. 8, 2023
(86) PCT No.: PCT/CN2023/130569

§ 371 Date: Mar. 31, 2026

(30) Foreign Application Priority Data
Nov. 15, 2022 (CN) 202211431941.1

(51) Int. Cl. F25J 1/00; F25J 1/02

(52) U.S. Cl. CPC F25J 1/0025; F25J 1/005; F25J 1/0062; F25J 1/0277; F25J 1/0284

(57) ABSTRACT

A cryogenic type boil-off gas reliquefaction system is provided. In a cooling loop having a compressor, an expander and a cooling apparatus, and inert gas is used as a refrigeration working medium, such that the refrigeration working medium can enter a heat exchanger at a very low temperature to cool a particularly liquid cooled working medium to be in a cryogenic state, and then the cryogenic cooled working medium returns to a storage facility to effectively reduce an evaporation amount in the storage facility. Therefore, evaporation in the storage facility is effectively reduced in a manner of simple system, small floor space, low device start-up and debugging costs, and simple maintenance and upkeep, thereby reducing transportation or storage costs.

### TECHNICAL FIELD

The present disclosure relates to the field of liquefied natural gas (LNG) storage and transportation, in particular to a processing system for boil-off gas in an LNG ship, and particularly relates to a cryogenic type boil-off gas reliquefaction system for the LNG ship.

### BACKGROUND

With the rapid development of economic society and modern industry, energy utilization and environmental pollution become the focus of world attention. In the face of increasingly severe environmental requirements, the transformation of international energy strategies is accelerated, and the development and application of clean fuels become important development directions of energy strategies. Natural gas has the characteristics of small pollutant emission and relatively low cost, such that the proportion of the natural gas in international energy supply is increased year by year, and the situation that the global natural gas consumption demand is rapidly increased is expected to continue until 2040. Compared with pipeline transportation of the natural gas, marine LNG transportation has the advantages of flexibility, and diversified production places and destinations because long transportation pipelines do not need to be laid and the natural gas can be flexibly transported around the world. With the continuous and dramatic increase of natural gas trade volume, the global LNG shipping industry will be rapidly developed, and 600 large LNG ship orders are expected to be newly added in the world by 2030.

In view of the special physical and chemical properties of the LNG, the LNG is inevitably partially evaporated into boil-off gas (BOG) during transportation of any LNG ships even if the thermal insulation property of a cargo tank is excellent. The production of the BOG can make pressure of the cargo tank rise and destroy the structure of the cargo tank. If the BOG is directly discharged into the atmosphere, direct economic loss and greenhouse harm are also caused. Therefore, a reliquefaction system for the BOG needs to be provided, and the reliquefaction system can recondensate and reliquefy the BOG in the cargo tank, reduce evaporation of the BOG in the cargo tank, reduce transportation cost, and improve safety of LNG transportation, and is an important high value-added device on large LNG transport ships and refueling ships at present. Such problems also exist in LNG storage facilities on land.

However, in an existing LNG boil-off gas reliquefaction system, from the process technology, when a mixed working medium reliquefaction mode is adopted, it leads to complicated flow and high maintenance difficulty, and working media such as propane are explosive gases, which have high leakage risk and high danger. When a nitrogen expansion reliquefaction mode is adopted, inert gas is used as a refrigeration working medium, the safety is high, but the system needs more auxiliary devices such as a boil-off gas compressor, a nitrogen generator, a boil-off gas heater and the like, the installation and debugging period is long, and the maintenance cost is high. Therefore, there is an urgent need to develop a safe, reliable, efficient, and low-cost boil-off gas reliquefaction system for the LNG.

### SUMMARY

To solve the above technical problems, the present disclosure provides a cryogenic type boil-off gas reliquefaction system especially for LNG ships. The reliquefaction system includes a cooling loop.

The cooling loop includes:
a compressor, configured to compress a refrigeration working medium of the reliquefaction system;
a cooler, configured to cool the compressed refrigeration working medium;
an expander, configured to expand the cooled refrigeration working medium;
a power apparatus, capable of driving the compressor to compress the refrigeration working medium; and
a heat exchanger, configured to generate heat exchange between the cooled working medium and the expanded refrigeration working medium,
where the refrigeration working medium operates in a closed cycle in the cooling loop, after the refrigeration working medium is compressed in the compressor, the refrigeration working medium is cooled by the cooler to reduce the temperature, then is expanded by the expander to reduce the pressure and the temperature, and then absorbs heat from the cooled working medium in the heat exchanger to reduce the temperature of the cooled working medium, and the refrigeration working medium after absorbing the heat enters the compressor to be compressed; and
the refrigeration working medium before entering the expander and the refrigeration working medium expanded by the expander flow in the heat exchanger in reverse directions and exchange heat.

Further, the cooled working medium in the heat exchanger is liquefied natural gas, and a flowing direction of liquefied natural gas in at least part of a section of the heat exchanger is opposite to a flowing direction of the expanded refrigeration working medium, where the refrigeration working medium adopts inert gas; preferably, the refrigeration working medium is selected from He, N₂, H₂, Ne, or a mixed gas of at least two of He, N₂, H₂, or Ne.

Further, at least two compressors are provided, and the at least two compressors are arranged in the cooling loop in series and/or in parallel, such that the refrigeration working medium flows through the at least two compressors in series and/or in parallel, where an outlet of each compressor is provided with a cooler; the refrigeration working medium expands in the expander to enable the expander to output energy, and at least one of the at least two compressors receives the energy output by the expander; and at least one of the at least two compressors is driven by the power apparatus, preferably, at least two power apparatuses are provided, and the power apparatuses are especially motors.

Further, at least one of the at least two compressors is arranged in a co-axial drive with the power apparatus and the expander, such that the at least one compressor is driven by the energy output by the power apparatus and the expander.

Further, at least two expanders are provided, and the at least two expanders are arranged in the cooling loop in series and/or in parallel, such that the refrigeration working medium flows through the at least two expanders in series and/or in parallel.

Further, the compressor is an axial compressor or a centrifugal compressor, and the expander is an axial expander or a centripedal expander.

Furthermore, the expander is provided with a bypass branch, one end of the bypass branch is connected to an inlet of the expander, the other end of the bypass branch is connected to an outlet of the expander, and preferably, a regulating valve is provided on the bypass branch and configured to regulate the refrigeration working medium flowing from the inlet of the expander to the outlet of the expander via the bypass branch; and especially, one end of the bypass branch is connected to a pipe section of the inlet of the expander located at an upstream part of the heat exchanger, and the other end of the bypass branch is connected to a pipe section of the outlet of the expander located at a downstream part of the heat exchanger.

Further, the reliquefaction system is provided with a power apparatus cooling branch, an upstream part of the power apparatus cooling branch is connected to an inlet pipeline of the expander and configured to guide the refrigeration working medium from the inlet pipeline of the expander, preferably, the upstream part of the power apparatus cooling branch is connected to the bypass branch, the power apparatus cooling branch flows through the power apparatus to be configured to cool the power apparatus, and the power apparatus cooling branch after flowing through the power apparatus is connected to an inlet of the compressor, where the power apparatus cooling branch preferably flows through a plurality of power apparatuses in series and/or in parallel, and the refrigeration working medium in the power apparatus cooling branch is preferably especially cooled after flowing through the power apparatuses and then fluidly connected to the inlet of the compressor.

Further, the power apparatus cooling branch further includes a power apparatus cooler; when the power apparatus cooling branch flows through the plurality of power apparatuses in series, after flowing through the power apparatus located at an upstream part, the refrigeration working medium in the power apparatus cooling branch is cooled by the power apparatus cooler and then flows into the next power apparatus; and
when the power apparatus cooling branch flows through the plurality of power apparatuses in parallel, after flowing through the power apparatus located at an upstream part, the refrigeration working medium in the power apparatus cooling branch is preferably cooled by the power apparatus cooler and then fluidly connected to the next power apparatus, or is preferably fluidly connected to the inlet of the compressor.

Further, the reliquefaction system is provided with a power apparatus leakage cooling branch, the power apparatus is cooled by a refrigeration working medium leaking into an interior of the power apparatus, and then the leaking refrigeration working medium is fluidly connected to an inlet of the compressor via the power apparatus leakage cooling branch.

After implementation, the present disclosure has the following beneficial effects: through the cryogenic type boil-off gas reliquefaction system of the present disclosure, the cooling loop including the compressor, the expander and the cooling apparatus is arranged, and inert gas is used as the refrigeration working medium in the cooling loop, such that the refrigeration working medium can enter the heat exchanger at a very low temperature to cool a particularly liquid cooled working medium to be in a cryogenic state, and then the cryogenic cooled working medium returns to a storage facility to effectively reduce an evaporation amount in the storage facility. Therefore, evaporation in the storage facility is effectively reduced in a manner of simple system, small floor space, low device start-up and debugging costs, and simple maintenance and upkeep, thereby reducing transportation or storage costs.

### BRIEF DESCRIPTION OF THE DRAWINGS

In order to more clearly illustrate the technical solutions of the present disclosure, the drawings required to be used in the description of the embodiments or the prior art are briefly introduced below. It is obvious that the drawings in the description below are merely some embodiments of the present disclosure, and those of ordinary skills in the art can obtain other drawings according to these drawings without creative efforts.

FIG. 1 is a system diagram of Embodiment 1 of the present disclosure.

FIG. 2 is a system diagram of Embodiment 2 of the present disclosure.

FIG. 3 is a system diagram of Embodiment 3 of the present disclosure.

Reference numerals: C101: first-stage compressor; C102: second-stage compressor; E101: expander; L200: bypass branch; L201: power apparatus cooling branch; L202: power apparatus cooling branch; L211: power apparatus cooling branch; L212: power apparatus cooling branch; L203: power apparatus leakage cooling branch; L213: power apparatus leakage cooling branch; S101: compression and expansion integrated machine; S103: first cooler; S104: second cooler; S105: heat exchanger; and S106: power apparatus cooler.

### DETAILED DESCRIPTION

The technical solutions in the embodiments of the present disclosure will be clearly and completely described below with reference to the drawings in the embodiments of the present disclosure, and it is obvious that the described embodiments are only a part of the embodiments of the present disclosure but not all of them. Based on the embodiments of the present disclosure, all other embodiments obtained by those of ordinary skills in the art without creative effort shall fall within the protection scope of the present disclosure.

In order to solve the above technical problems, the present disclosure provides a cryogenic type boil-off gas reliquefaction system, particularly a cryogenic type boil-off gas reliquefaction system for liquefied natural gas (LNG) ships. Of course, the cryogenic type boil-off gas reliquefaction system of the present disclosure can be used for LNG facilities on land, such as LNG storage tanks on land, and the like. The cryogenic type boil-off gas reliquefaction system cools a cooled working medium (especially LNG) by a cryogenic refrigeration working medium in a cooling loop, and then conveys the cooled working medium back to a storage facility for reducing the temperature in the storage facility, thereby reducing evaporation in the storage facility.

### Embodiment

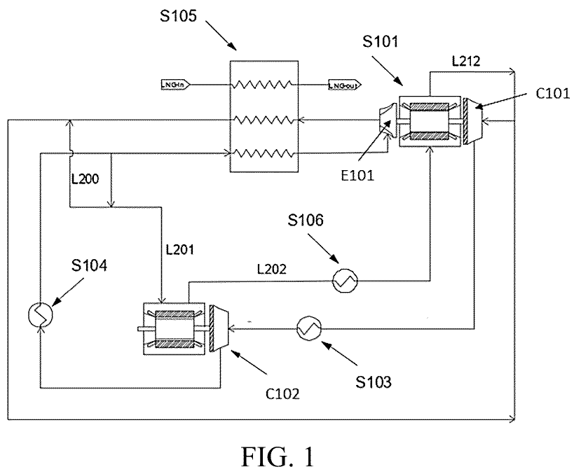

As shown in FIG. 1, the cryogenic type boil-off gas reliquefaction system includes a cooling loop, a refrigeration working medium circulating in a closed manner is provided in the cooling loop, and the refrigeration working medium is inert gas here, which may be He, N₂ or a mixed gas of He and N₂. The inert gas is used as the refrigeration working medium of the cooling loop, such that the cooling loop can provide cryogenic cooling capacity to cool liquid LNG. In particular, the liquid LNG can be cooled to be in a supercooled state, and when the supercooled LNG returns to a storage apparatus, the temperature in the storage apparatus can be lowered, thereby reducing evaporation of the LNG in the storage apparatus.

The cooling loop includes: a first-stage compressor C101 and a second-stage compressor C102, configured to compress the refrigeration working medium, where the first-stage compressor C101 and the second-stage compressor C102 are arranged in series, that is, the refrigeration working medium flows through the first-stage compressor C101 and the second-stage compressor C102 in series to be compressed in two stages; and a first cooler S103 and a second cooler S104, configured to cool the refrigeration working medium compressed by the first-stage compressor C101 and the second-stage compressor C102. The first-stage compressor C101, the first cooler S103, the second-stage compressor C102, and the second cooler S104 are sequentially fluidly connected in series along a flowing direction of the refrigeration working medium. Specifically, the first cooler S103 is connected to an outlet of the first-stage compressor C101 through a pipeline, an inlet of the second-stage compressor C102 is connected to the first cooler S103 through a pipeline, and the second cooler S104 is connected to an outlet of the second-stage compressor C102 through a pipeline. Therefore, the refrigeration working medium at normal temperature and normal pressure (not normal temperature and normal pressure relative to ambient temperature, but relative state of a refrigeration working medium circulating in the cooling loop, and high temperature, low temperature, medium pressure, high pressure, and low pressure described below are also the same) is compressed by the first-stage compressor C101 to become a refrigeration working medium at high temperature and medium pressure, then is cooled by the first cooler S103 to become a refrigeration working medium at normal temperature and medium pressure, then is compressed by the second-stage compressor C102 to become a refrigeration working medium at high temperature and high pressure, and then is cooled by the second cooler S104 to become a refrigeration working medium at normal temperature and high pressure.

The cooling loop further includes an expander E101, an inlet of the expander E101 is fluidly connected to the second cooler S104 and configured to expand the refrigeration working medium at normal temperature and normal pressure that is compressed by the two stages of compressors and cooled by the two stages of coolers. In the expander E101, the refrigeration working medium at normal temperature and normal pressure expands, that is, the volume increases, such that the pressure and the temperature decrease, and the refrigeration working medium at normal temperature and normal pressure is expanded by the expander E101 to become a refrigeration working medium at low temperature and low pressure. When the inert gas such as He, N₂ or a mixed gas of He and N₂ is selected as the refrigeration working medium, the inert gas such as He, N₂ or a mixed gas of He and N₂ at low temperature and low pressure can provide cryogenic cooling capacity.

Here, in order to cool the LNG, the cooling loop includes a heat exchanger S105, and heat is exchanged between the refrigeration working medium at low temperature and low pressure that has cryogenic capability and the LNG in the heat exchanger S105. Specifically, the LNG transfers heat to the refrigeration working medium at low temperature and low pressure, thereby further reducing the temperature of the LNG. The heat exchanger S105 may be a multi-flow heat exchanger. As shown in FIG. 1, in at least part of a section of the heat exchanger S105, a fluid flowing direction of the LNG is opposite to a fluid flowing direction of the refrigeration working medium, that is, the LNG and the refrigeration working medium perform heat transfer in the heat exchanger S105 in a relatively counter-flow manner, which can improve the efficiency of heat transfer and the cooling effect of the LNG.

Meanwhile, in the heat exchanger S105, the refrigeration working medium at low temperature and low pressure still has a low temperature after absorbing the heat of the LNG, such that the heat exchanger S105 can be used as a heat regenerator, and the refrigeration working medium at low temperature and low pressure that is output by the expander E101 in the heat exchanger S105 cools the refrigeration working medium at normal temperature and high pressure at the inlet of the expander E101, so as to further reduce the air intake temperature of the expander E101, thereby achieving the purpose of saving energy. Similarly, as shown in FIG. 1, in at least part of the section of the heat exchanger S105, a fluid flowing direction of the refrigeration working medium at normal temperature and high pressure at the inlet of the expander E101 is opposite to a fluid flowing direction of the refrigeration working medium at low temperature and low pressure that is output by the expander E101, that is, the LNG and the refrigeration working medium perform heat transfer in the heat exchanger S105 in a relatively counter-flow manner, which can improve the efficiency of heat transfer and the cooling effect.

Therefore, the refrigeration working medium sequentially flows through the first-stage compressor C101, the first cooler S103, the second-stage compressor C102, the second cooler S104, the heat exchanger S105, the expander E101, and the heat exchanger S105, and then returns to the inlet of the first-stage compressor C101, thereby completing one cycle in the cooling loop. The reciprocating cycle can provide continuous cryogenic capability to the LNG.

The first-stage compressor C101 and the second-stage compressor C102 may be axial compressors and/or centrifugal compressors, and the expander E101 may be an axial expander or a centrifugal expander.

Since the compressor converts external energy into internal energy of the compressed gas, the compressor needs to be driven by external power to operate. In the embodiment, the cooling loop further includes two power apparatuses, where the power apparatuses are motors, and the two motors respectively drive the first-stage compressor C101 and the second-stage compressor C102, and are configured to convert mechanical energy output by the motors into internal energy of the refrigeration working medium at the compressors.

The refrigeration working medium expands in the expander E101, and then acts on the expander E101, such that the expander E101 rotates to output mechanical energy. Here, in order to improve the operation effect of the system by using the energy output by the expander E101, as shown in FIG. 1, the expander E101, one motor, and the first-stage compressor C101 are mounted on a common rotating shaft to form a compression and expansion integrated machine S101, such that the mechanical energy output by the motor and the mechanical energy output by the expander E101 can be transmitted to the first-stage compressor C101 through the common rotating shaft, thereby improving the energy use efficiency. Alternatively, of course, the expander E101 may be mounted on a common rotating shaft with the second-stage compressor C102 to form a compression and expansion integrated machine, while the first-stage compressor C101 is driven by a motor separately; or two expanders which are arranged in series or in parallel may be provided, and each expander and the corresponding compressor may be coaxial to form a compression and expansion integrated machine to drive the compressor. It is claimed that the compression and expansion integrated machine may only include the compressor and the expander which rotate coaxially, or may include the compressor, the expander and the motor which rotate coaxially.

Further alternatively, in order to improve the refrigeration capacity of the cooling loop, a plurality of compressors and a plurality of expanders may be included. Three or more compressors are provided, and two or more expanders are provided, where the plurality of compressors are arranged in series, in parallel, or in series and in parallel. Specifically, each compressor may be driven by the motor alone, or may be driven coaxially by the motor and the expander together, thereby constituting the cryogenic type boil-off gas reliquefaction system having higher refrigeration capacity.

As shown in FIG. 1, a bypass branch L200 is further provided in the cooling loop. Specifically, an upstream end of the bypass branch L200 is connected to a pipe section between the second cooler S104 and the heat exchanger S105, and a downstream end of the bypass branch L200 is connected to a pipe section between the heat exchanger S105 and the first-stage compressor C101, so as to partially deliver the refrigeration working medium at high pressure that is compressed by two stages into the first-stage compressor C101 for anti-surge backflow and pressure and temperature regulation during startup in the system. Further, in order to achieve a regulating effect, a regulating valve not shown in FIG. 1 is preferably provided on the bypass branch and configured to regulate the refrigeration working medium flowing from the inlet of the expander to the outlet of the expander via the bypass branch, particularly regulate the flow or pressure.

The motor generates a lot of heat in the process of driving the compressor to operate. In order to cool the motor and prevent the motor from overheating and affecting the operation, as shown in FIG. 1, power apparatus cooling branches L201 and L202 are further provided in the cooling loop, and the power apparatus cooling branches L201 and L202 are arranged in series. An upstream part of the power apparatus cooling branch L201 is connected to an inlet pipeline of the expander E101 for guiding the refrigeration working medium from the inlet pipeline of the expander E101, where preferably the upstream part of the power apparatus cooling branch L201 is connected to the bypass branch L200. The refrigeration working medium at normal temperature and high pressure flows into the motor of the second-stage compressor C102 via the power apparatus cooling branch L201 and flows through air gaps of a stator and a rotor of the motor so as to reduce the temperature of the stator and the rotor of the motor. Meanwhile, the refrigeration working medium adopts the inert gas and can further play a role in sealing the motor. After cooling the motor of the second-stage compressor C102 and then flowing through a power apparatus cooler S106 via the power apparatus cooling branch L202 to be further cooled, the refrigeration working medium enters the motor of the first-stage compressor C101 to cool the motor of the first-stage compressor C101, and directly flows into the inlet of the first-stage compressor C101 through the power apparatus cooling branch L212 after being cooled.

The power apparatus cooling branches L201 and L202 in FIG. 1 are preferably provided with regulating valves for regulating the flow or pressure of the refrigeration working medium flowing through the motors. Meanwhile, the power apparatus cooling branches L201 and L202 are arranged in series, a pressure difference between the pressure of the refrigeration working medium at the outlet of the second-stage compressor C102 and the pressure of the refrigeration working medium at the inlet of the first-stage compressor C101, and a pressure drop of the refrigeration working medium when flowing the motor of the first-stage compressor C101 and the motor of the second-stage compressor C102 are fully considered, thereby ensuring that the motors can be fully cooled. Here, an independent cooling apparatus may be additionally provided on the power apparatus cooling branch L212, so as to cool the refrigeration working medium and then flow into the inlet of the first-stage compressor C101, such that the influence on the temperature of the refrigeration working medium at the inlet of the first-stage compressor C101 can be reduced, thereby improving the subsequent compression efficiency.

### Embodiment

The present disclosure further provides another embodiment, details of the same parts as those in Embodiment 1 are not repeated herein, and only different contents from those in Embodiment 1 are described.

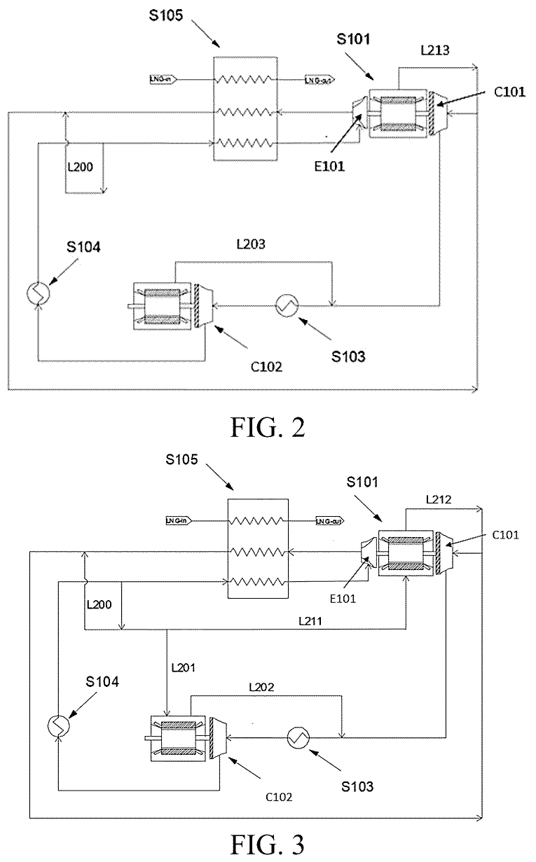

As shown in FIG. 2, for cooling of motors of a first-stage compressor C101 and a second-stage compressor C102, the power apparatuses are cooled by the refrigeration working medium leaking from the compressors to the interiors of the motors, and the two motors are cooled separately. After cooling the motors, the leaking refrigeration working medium is fluidly connected to the inlets of the first-stage compressor C101 and the second-stage compressor C102 via power apparatus leakage cooling branches L203 and L213, respectively. In addition, independent cooling apparatuses may be additionally provided on the power apparatus leakage cooling branches L203 and L213, so as to cool the refrigeration working medium and then flow into the inlet of the first-stage compressor C101 and the inlet of the second-stage compressor C102, such that the influence on the temperature of the refrigeration working medium at the inlet of the first-stage compressor C101 and the inlet of the second-stage compressor C102 can be reduced, thereby improving the subsequent compression efficiency.

In the embodiment, for the cooling arrangement for the motors, a motor cooling sealing air source is taken from a part of refrigerant leaking from compression ends to motor cavities, the quantity of interfaces on the motor shell side is small, leakage risks can be reduced, pressure loss of system pipelines caused by an elbow, a branch pipe and the like is reduced, device cost is reduced, but cooling capacity is relatively small, and the reliquefaction system is applicable to low-rotating-speed and low-power motors which generate less heat.

### Embodiment

The present embodiment differs from Embodiment 1 in the cooling arrangement for two motors.

As shown in FIG. 3, after the refrigeration working medium is guided into power apparatus cooling branches from a bypass branch L200, cooling pipelines of two motors are arranged in parallel, and compared with Embodiment 1, in such parallel arrangement, cooling air of the two motors is directly led out from the bypass branch L200, such that the quantity of heat exchangers and the requirement for cooling water are reduced, the pressure of the refrigeration working medium for cooling each motor can be increased, and thus the cooling effect can be at least partially improved.

Specifically, as shown in FIG. 3, a power apparatus cooling branch L201 guides the refrigeration working medium from the bypass branch to a motor of a second-stage compressor C102 to cool the motor, and then the refrigeration working medium is discharged from the motor and introduced into the upstream part of a first cooler S103, and then enters an inlet of the second-stage compressor C102. A power apparatus cooling branch L211 guides the refrigeration working medium from the bypass branch to enter a motor of a first-stage compressor C101 to cool the motor, and then the refrigeration working medium is discharged from the motor and then introduced into the inlet of the second-stage compressor C102.

In addition, independent cooling apparatuses are additionally provided on the power apparatus cooling branches L202 and L212, so as to cool the refrigeration working medium and then flow into the inlet of the first-stage compressor C101 and the inlet of the second-stage compressor C102, such that the influence on the temperature of the refrigeration working medium at the inlet of the first-stage compressor C101 and the inlet of the second-stage compressor C102 can be reduced, thereby improving the subsequent compression efficiency.

After implementation, the present disclosure has the following beneficial effects: through the cryogenic type boil-off gas reliquefaction system of the present disclosure, the cooling loop including the compressor, and the expander and the cooling apparatus is arranged, inert gas is used as the refrigeration working medium in the cooling loop, such that the refrigeration working medium can enter the heat exchanger at a very low temperature to cool a particularly liquid cooled working medium to be in a cryogenic state, and then the cryogenic cooled working medium returns to a storage facility to effectively reduce an evaporation amount in the storage facility. Meanwhile, the refrigeration working medium runs in the cooling loop in a fully-closed circulation manner, and is mutually independent of the flow of the cooled working medium, and the system is high in safety, few in device and simple in flow. Therefore, evaporation in the storage facility is effectively reduced in a manner of simple system, small floor space, low device start-up and debugging costs, and simple maintenance and upkeep, thereby reducing transportation or storage costs.

The above disclosure is only a few of preferred embodiments of the present disclosure. Of course, they can not be used to limit the scope of the present disclosure, and therefore, equivalent changes according to the claims of the present disclosure are still covered by the scope of the present disclosure.

1. A cryogenic type boil-off gas reliquefaction system, comprising
a cooling loop, the cooling loop comprising:
a first-stage compressor and a second-stage compressor, configured to compress a refrigeration working medium of the reliquefaction system;
a first cooler and a second cooler, configured to cool the compressed refrigeration working medium;
an expander, configured to expand the cooled refrigeration working medium;
a power apparatus, capable of driving the compressor to compress the refrigeration working medium; and
a heat exchanger, configured to generate heat exchange between the cooled working medium and the expanded refrigeration working medium,
wherein a refrigerant flows sequentially through the first-stage compressor, the first cooler, the second-stage compressor, the second cooler, the heat exchanger, the expander, and the heat exchanger in the cooling circuit and return to an inlet of the first-stage compressor;
wherein the expander is provided with a bypass branch, one end of the bypass branch is connected to pipe section between the second cooler and the heat exchanger, and the other end of the bypass branch is connected to a pipe section between the heat exchanger and the first-stage compressor; and
the reliquefaction system is provided with a power apparatus cooling branch, an upstream part of the power apparatus cooling branch is connected to the bypass branch, the power apparatus cooling branch flows through the power apparatus to be configured to cool the power apparatus, and the power apparatus cooling branch after flowing through the power apparatus is connected to an inlet of the compressor; or the reliquefaction system is further provided with a power apparatus leakage cooling branch, the power apparatus is cooled by a refrigeration working medium leaking into an interior of the power apparatus, and then the leaking refrigeration working medium is fluidly connected to an inlet of the compressor via the power apparatus leakage cooling branch.

2. The cryogenic type boil-off gas reliquefaction system according to claim 1, wherein the cooled working medium in the heat exchanger is liquefied natural gas, and a flowing direction of liquefied natural gas in at least part of a section of the heat exchanger is opposite to a flowing direction of the expanded refrigeration working medium, wherein the refrigeration working medium adopts inert gas.

3. The cryogenic type boil-off gas reliquefaction system according to claim 1, wherein the refrigeration working medium is selected from He, N₂, H₂, Ne, or a mixed gas of at least two of He, N₂, H₂, or Ne.

4. The cryogenic type boil-off gas reliquefaction system according to claim 1, wherein at least two compressors are provided, and the at least two compressors are arranged in the cooling loop in series and/or in parallel, wherein an outlet of each compressor is provided with a cooler; the refrigeration working medium expands in the expander to enable the expander to output energy, and at least one of the at least two compressors receives the energy output by the expander; and at least one of the at least two compressors is driven by the power apparatus.

5. The cryogenic type boil-off gas reliquefaction system according to claim 4, wherein at least two power apparatuses are provided, and the power apparatuses are motors.

6. The cryogenic type boil-off gas reliquefaction system according to claim 4, wherein at least one of the at least two compressors is arranged in a co-axial drive with the power apparatus and the expander.

7. The cryogenic type boil-off gas reliquefaction system according to claim 4, wherein at least two expanders are provided, and the at least two expanders are arranged in the cooling loop in series and/or in parallel.

8. The cryogenic type boil-off gas reliquefaction system according to claim 1, wherein the compressor is an axial compressor or a centrifugal compressor, and the expander is an axial expander or a centripedal expander.

9. The cryogenic type boil-off gas reliquefaction system according to claim 1, wherein one end of the bypass branch is connected to a pipe section of the inlet of the expander located at an upstream part of the heat exchanger, and the other end of the bypass branch is connected to a pipe section of the outlet of the expander located at a downstream part of the heat exchanger.

10. The cryogenic type boil-off gas reliquefaction system according to claim 9, wherein a regulating valve is provided on the bypass branch and configured to regulate the refrigeration working medium flowing from the inlet of the expander to the outlet of the expander via the bypass branch.

11. (canceled)

12. The cryogenic type boil-off gas reliquefaction system according to claim 10, wherein the power apparatus cooling branch flows through a plurality of power apparatuses in series and/or in parallel, and the refrigeration working medium in the power apparatus cooling branch is cooled after flowing through the power apparatuses and then fluidly connected to the inlet of the compressor.

13. The cryogenic type boil-off gas reliquefaction system according to claim 12, wherein the power apparatus cooling branch further comprises a power apparatus cooler;
when the power apparatus cooling branch flows through the plurality of power apparatuses in series, after flowing through the power apparatus located at an upstream part, the refrigeration working medium in the power apparatus cooling branch is cooled by the power apparatus cooler and then flows into the next power apparatus; and
when the power apparatus cooling branch flows through the plurality of power apparatuses in parallel, after flowing through the power apparatus located at an upstream part, the refrigeration working medium in the power apparatus cooling branch is cooled by the power apparatus cooler and then fluidly connected to the next power apparatus, or is fluidly connected to the inlet of the compressor.

14. (canceled)
